(19) United States
(12) Patent Application Publication
(10) Pub. No.: US 2017/0212652 A1
(43) Pub. Date: Jul. 27, 2017

(54) DUAL-MEDIA VISUAL INDICATOR

(71) Applicant: NANOPORT TECHNOLOGY INC., Markham (CA)

(72) Inventor: Timothy Jing Yin SZETO, Markham (CA)

(21) Appl. No.: 15/153,784

(22) Filed: May 13, 2016

Related U.S. Application Data
(60) Provisional application No. 62/281,675, filed on Jan. 21, 2016.

(51) Int. Cl. G06F 3/0484; G06T 13/80; G06F 3/041

(52) U.S. Cl. CPC G06F 3/0484; G06F 3/0416; G06T 13/80; G06T 2200/24

(57) ABSTRACT

A device configured to provide a first visual indicator portion defined by at least part of a display and a second visual indicator portion defined by a plurality of light sources disposed in a bezel. The first visual indicator portion and the second visual indicator portion being in close physical proximity and cooperatively forming a dual-media visual indicator. The device configured to execute instructions in a storage unit to issue a first control command for the first visual indicator portion, and a second control command for the second visual indicator portion, thereby controlling the first visual indicator portion and the second visual indicator portion to generate a visual effect of the dual-media visual indicator.

### FIELD

The present disclosure generally relates to the field of mobile devices.

### INTRODUCTION

Mobile devices have indicators to show power/on off status and charging activity. Mobile devices have buttons to trigger a control action, such as navigating applications of a device, for example. There is a need for improved indicators and buttons to provide an enhanced user experience.

### SUMMARY

In accordance with one aspect, there is provided a device having a processor, a storage unit, a display, and a plurality of light sources disposed in a bezel adjacent the display. The device is configured to provide a first visual indicator portion defined by at least part of the display and a second visual indicator portion defined by the plurality of light sources disposed in the bezel. The first visual indicator portion and the second visual indicator portion are in close physical proximity and cooperatively forming a dual-media visual indicator. The processor is configured to execute instructions in the storage unit to issue a first control command for the first visual indicator portion, and a second control command for the second visual indicator portion, thereby controlling the first visual indicator portion and the second visual indicator portion to generate a visual effect of the dual-media visual indicator.

In some embodiments, upon touch activation of the dual-media indicator, the first visual indicator portion transmits a first user input signal to the processor and the second visual indicator portion transmits a second user input signal to the processor, the processor being responsive to the first user input signal and the second user input signal for controlling operation of the device.

In some embodiments, the processor controls the first visual indicator portion and the second visual indicator portion using the first control command and the second control command, respectively, to generate the visual effects in synchronization across the first visual indicator portion and the second visual indicator portion.

In some embodiments, the dual-media visual indicator has a plurality of event states to trigger different user input commands depending on a current event state.

In some embodiments, the processor selectively activates the first visual indicator portion and the second visual indicator portion using the first control command and the second control command to generate the visual effect.

In some embodiments, the first control command and the second control command are different types of control commands for controlling the display and the plurality of light sources, respectively.

In some embodiments, the second visual indicator portion comprises a microcontroller for controlling the plurality of light sources, the microcontroller being responsive to the second control command.

In some embodiments, the second visual indicator portion is formed as a plurality of apertures on the bezel aligned with the plurality of light sources to emit light through the apertures.

In some embodiments, the processor generates the visual effect by controlling the plurality of light sources to emit light through the apertures using the second control command.

In some embodiments, the apertures are sized to not be visible to eye when the plurality of light sources are not emitting light.

In some embodiments, a transparent cover over at least one of the apertures.

In some embodiments, at least one lens to focus light from the plurality of light sources through the apertures.

In some embodiments, the plurality of light sources are embedded on the bezel.

In some embodiments, the device comprises a microcontroller for controlling the plurality of light sources, the microcontroller being responsive to the second control command.

In some embodiments, the processor controls the first visual indicator portion using a display bus coupled to the display and the second visual indicator portion using a microcontroller for controlling the plurality of light sources.

In some embodiments, the processor controls the first visual indicator portion and the second visual indicator portion in synchronization to define a visual element within the indicator region during operation of the device.

In some embodiments, the processor determines a device state and triggers the first control command and the second control command to generate the visual effect to indicate the device state.

In some embodiments, the second visual indicator portion is formed by the plurality of light sources as a plurality of discrete elements.

In some embodiments, the second visual indicator portion is formed by the plurality of light sources as a continuous element.

In some embodiments, the second visual indicator portion is visible when the display is deactivated.

In some embodiments, the processor triggers the first control command and the second control command to generate, as the synchronized visual effects, a plurality of visual animation effects to indicate different device states.

In some embodiments, the part of the display defining the first visual indicator portion is touch sensitive providing the touch activation for the dual-media visual indicator.

In some embodiments, the bezel includes a touch sensor, providing touch activation for the dual-media visual indicator.

In another aspect, the disclosure relates to a system of a series of magnetically connected devices. Each device has a processor, a storage unit, a display, a plurality of light sources disposed in a bevel adjacent the display. A device is configured to provide a first visual indicator portion defined by at least a part of the display and a second visual indicator portion defined by at least the plurality of light sources disposed in a bevel. The first visual indicator portion and the second visual indicator portion being in close physical proximity and cooperatively forming a dual-media indicator. The connected devices configured to exchange control signals to generate a synchronized visual effect across the dual-media indicators of the magnetically connected devices. Each device is configured to execute instructions in the storage unit to issue a first control command for its first visual indicator portion, and a second control command for its second visual indicator portion, thereby controlling the first visual indicator portion and the second visual indicator portion to generate a portion of the synchronized visual effect.

In another aspect, the disclosure relates to a process for generating a synchronized visual effect for a dual-media visual indicator on a device, the synchronized visual effect being an animation sequence including a first portion presented on a display of the device, a second portion presented on a bezel of the device by a light source, and a third portion presented on the display. The process involves: transmitting a first display control command for a first portion of the animation sequence to the display of the device by way of a display bus, the first display control command comprising a first visual display animation sequence; transmitting a light control command for a second portion of the animation sequence to a microcontroller by way of a control bus, the light control command describing a visual light sequence for activation by the microcontroller; and transmitting a second display control command for a third portion of the animation sequence to the display by way of a display bus, the second display control command comprising a second visual display animation sequence.

In some embodiments, the process involves receiving an interrupt signal from the microcontroller after displaying the visual light sequence.

In some embodiments, the process involves configuring the processor with a time duration of the second portion to trigger the third portion after the time duration has elapsed so that the microcontroller does not need to send an interrupt signal.

In some embodiments, the process involves storing a number of pre-defined sequences in a memory of the microcontroller, wherein the control data identifies one of the pre-defined sequences for the visual light sequence.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. The description and figures are only for illustration and as an aid to understanding.

Embodiments will now be described, by way of example only, with reference to the attached figures, wherein in the figures:

FIG. 1 is a view of an example of a device having a visual indicator according to some embodiments.

FIG. 2 is a magnified view of a region of FIG. 1 containing the visual indicator.

FIG. 3 is another example visual indicator according to some embodiments.

FIG. 4 is magnified view of a light source underneath a corresponding aperture for a visual indicator portion.

FIGS. 5A and 5B are views of an example of a device where a visual indicator portion is visible when emitting light and not visible when not emitting light.

FIG. 6 is a view of an example visual animation effect according to some embodiments.

FIG. 7 is a view of connected devices with magnetic connectors according to some embodiments.

FIG. 8 is a view of another example visual animation effect according to some embodiments.

FIG. 9 is a view of components of the device according to some embodiments.

FIG. 10 is a view of a system architecture for controlling of the light sources and the display screen of the device according to some embodiments.

FIG. 11 is a flowchart of a process for generating visual effects for the visual indicator according to some embodiments.

### DETAILED DESCRIPTION

Embodiments of methods, systems, and apparatus are described through reference to the drawings.

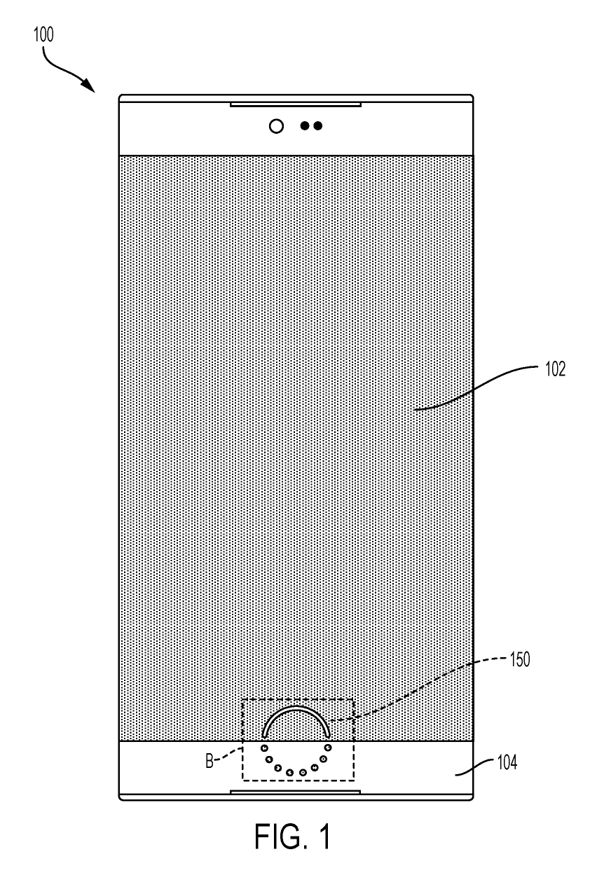

FIG. 1 depicts a device 100 (e.g., a smartphone, a tablet, or the like) having a visual indicator 150 in region B. The device 100 has a display screen 102 and a bezel 104 adjacent the display screen 102.

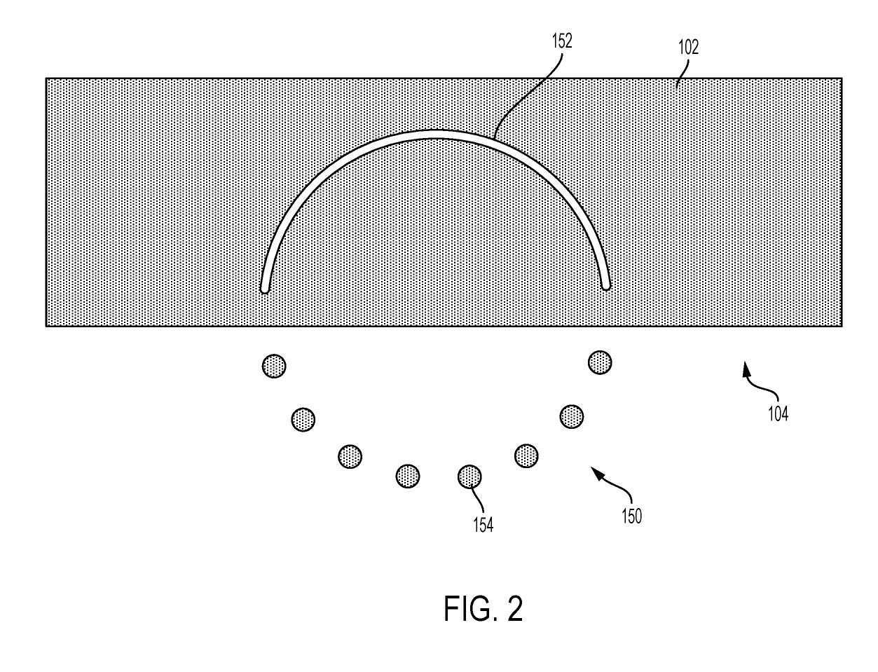

FIG. 2 is a magnified view of region B of FIG. 1 containing indicator 150. The indicator 150 is referred to as a dual-media visual indicator. A first visual indicator portion 152 is defined by part of the bottom of the display screen 102 in this illustrative example. A second visual indicator portion 154 is defined by light sources disposed in the bezel 104. The first visual indicator portion 152 and the second visual indicator portion 154 are in close physical proximity and cooperatively form the indicator 150. Indicator 150 spans an interface of display screen 102 and bezel 104. As such, indicator 150 includes a first visual indicator portion 152 that is displayed digitally on the display screen 102 and a second visual indicator portion 154 that is formed as part of bezel 104 by light sources disposed therein.

This example shows indicator 150 located on the bottom portion of device 100. Indicator 150 may also be located elsewhere on device 100, e.g., at the top of screen 102 or along one of its side edges.

Display screen 102 may be implemented as different types of display screens, e.g., a LCD, LED, OLED display, or the like. The first visual indicator portion 152 is formed by controlling the display of pixels on screen 102 using control commands. The display screen 102 provides an interface including one or more visual elements for the first visual indicator portion 152. The visual elements provide visual effects, as will be described herein. The visual elements may vary depending on the device state, the occurrence of different events, user configurations, and so on.

Bezel 104 is part of the housing of device 100, which may be formed by different housing materials such as metal (e.g., aluminum, steel, or the like) or plastics, glass, and so on. In some embodiments, bezel 104 may be adjacent the top of display screen 102. In some embodiments, bezel 104 may be adjacent the left or right side of the display screen 102 and indicator may be located on the side of the display screen 102. Bezel 104 may be formed into different shapes.

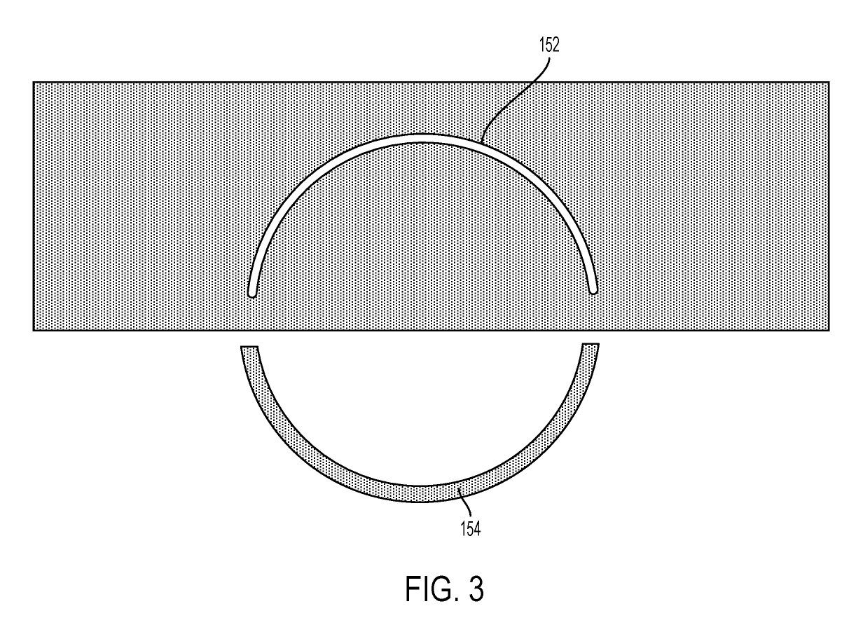

The second visual indicator portion 154 is formed as physical features in the bezel. As will be elaborated upon with reference to FIG. 3, in some embodiments, the second visual indicator portion 154 is formed as a sequence of apertures in bezel 104. The device 100 may include light sources (e.g., one or more LEDs) under the surface of bezel 104 that align with the apertures and emit light through the apertures to illuminate the second visual indicator portion 154. The light sources may be controlled using control commands to generate different visual effects.

In another example, the second visual indicator portion 154 is formed as a sequence of light sources (e.g., one or more LEDs, or one or more fiber optic light sources) embedded in bezel 104. In another example, second visual indicator portion 154 may be formed as an etching, engraving, painted feature, etc.

First and second indicator portions 152 and 154 can cooperate to define a pre-determined shape during operation of device 100. Specifically, a part of the shape is formed by indicator portion 152 and another part is formed by indicator portion 154. The shape may be animated in some embodiments. This is an example visual effect. In some embodiments, indicator 150 may be used to depict shape representative of a logo or trademark, e.g., indicating a brand of device 100. This is an example visual element. Additionally, the shape of the first indicator portion 152 may be generated dynamically on the display screen 102 to match the shape of the second indicator portion 154 (which is defined by the placement of the apertures and therefore static). For example, in FIG. 2, each portion approximately defines a semi-circle which together form a circle shape.

The cooperation of at least two media provides an enhanced indicator 150. The first visual indicator portion 152 may provide a first visual notification and the second visual indicator portion 154 may provide a second visual notification. The first notification and the second notification may both relate to a current device state to provide an enhanced visual notification to a user.

Indicator 150 may be used to provide an indication of the device state, e.g., a power charging state, a pairing state, etc. The indicator 150 has a visual effect that may be used to indicate different device states. For example, a pairing state has one or more corresponding visual effects to indicate that device 100 is magnetically connected to one or more other devices 100. As another example, a charging state has one or more corresponding visual effects to indicate the current power level of the device 100 and whether the device is currently charging. An indicator portion 152 may indicate the level of battery remaining and the other indicator portion 154 may indicate a charging state. Further examples of device states include bandwidth available, strength of wireless network signal, booting up, powering down, and loading an application.

In the example embodiment, indicator 150 has a circular shape. However, indicator 150 may be formed to take on other desired shapes, e.g., square, oval, rectangle, heart.

In the depicted example, indicator portion 154 includes eight discrete elements. However, there could be more or fewer elements. The elements are arranged according to part of the desired shape. The elements may be light sources or apertures aligned with light sources, for example. In one example, indicator portion 154 could be formed of one continuous element (FIG. 3). There may be discrete light sources positioned under the surface of the continuous element and illuminated in sequence or accordance with a pattern to provide visual effects.

As mentioned, indicator portion 154 may be formed as a sequence of apertures (an example of the discrete elements) in bezel 104, with one or more light sources located under the apertures to emit light the apertures. For example, the light sources could be a bank of LEDs, each LED having a location matched to below a corresponding aperture. The light sources could also extend at least partially through the apertures.

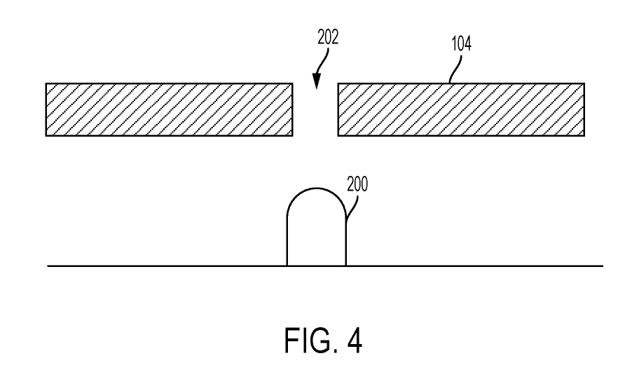

FIG. 4 shows an LED 200 under a corresponding aperture 202. Aperture 202 may be circular, or have another shape. An aperture 202 may be positioned to align with the position of LED 200 so that light emits through the aperture 202. An aperture 202 may have a diameter (width) of less than 1 mm (e.g., 0.8 mm, 0.5 mm). In some embodiments, an aperture 202 may have a diameter substantially less than 1 mm (e.g., 50-500 microns), such that it is not visible to the eye when not emitting light.

An aperture 202 may be filled by a transparent cover to pass light from LED 200. One or more lenses may be used to focus light from LED 200 through the apertures. The lens can be made of glass, plastic or a combination thereof. In an example embodiment, the lens is a Fresnel lens.

LED 200 may be a small conventional LED, e.g., 10-50 mW, or 50-100 mW. Luminous flux of each LED may be between 1-10 lumens, or greater, e.g., 20-50 lumens. LED 200 may be a single colour LED, or a multi-colour LED. LED 200 may be selectively activated under software control of device 100 to generate visual effects. The colour of LED 200 may also be under software control of device 100 to generate visual effects.

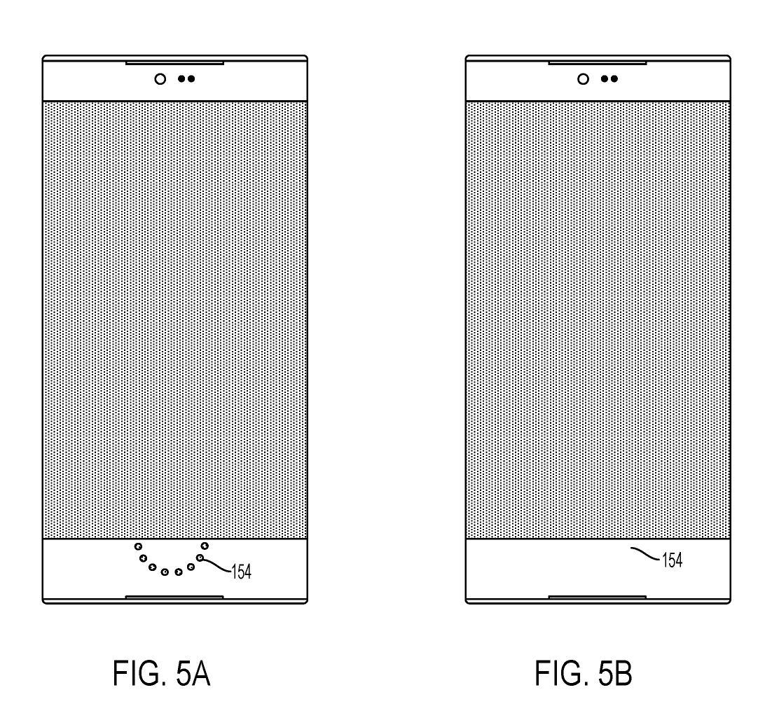

FIG. 5A shows device 100 with display screen 102 off such that only indicator portion 154 is visible. FIG. 5B shows device 100 having a second visual indicator portion 154 formed of small apertures 202 that are not visible to the eye when the light source is not emitting light. No part of indicator 150 is visible when the light source is not emitting light, as may be the case when the device is powered off, for example.

In some embodiments, portions of indicator 150 may be selectively activated (and/or change colour) to create an animation sequence, which may be referred to as visual effects. The sequence of animations may be used to provide a visual effect that indicates a state of device 100. The visual media indicator portions 152, 154 may operate in a synchronized manner to generate synchronized visual effects including animation sequences.

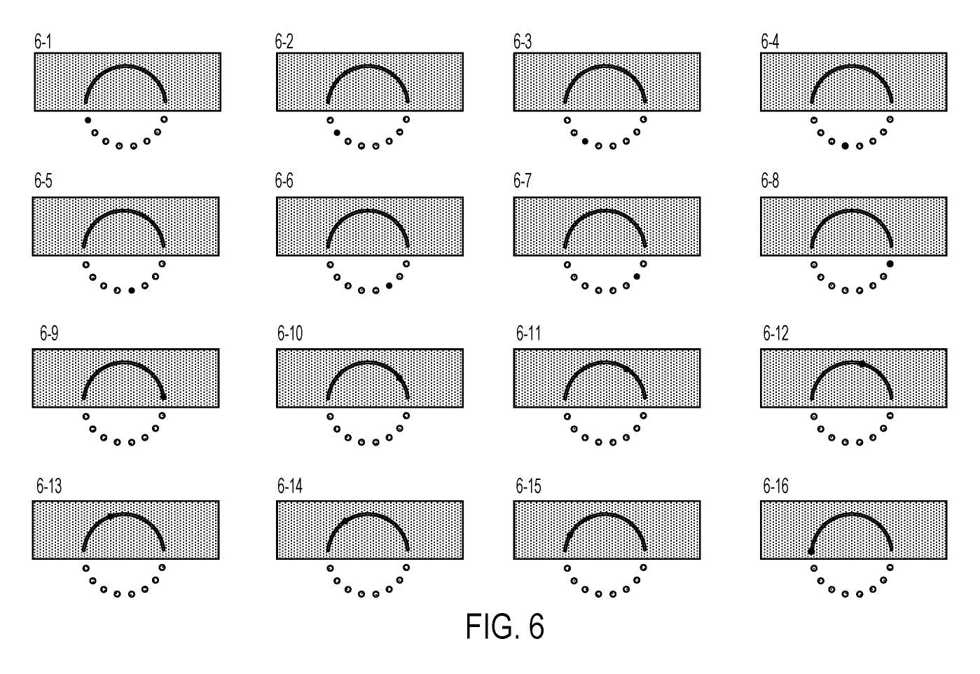

For example, FIG. 6 depicts an example animation sequence consisting of sixteen states of indicator 150. Different examples of indicator 150 are labelled with references 6-1 to 6-16 to show different visual effects for the sixteen states. This animation sequence shows a portion of the indicator 150 moving in a counter clockwise direction. Display of the animation sequence requires control by device 100 of both the LEDs forming indicator portion 154 and pixels of display 102 forming indicator portion 152. Various other animated sequences and states are possible. Different animated sequences indicate different device states. For example, the sequence of FIG. 6 may be used to indicate that the device is charging, or that the device is connecting to a WiFi network.

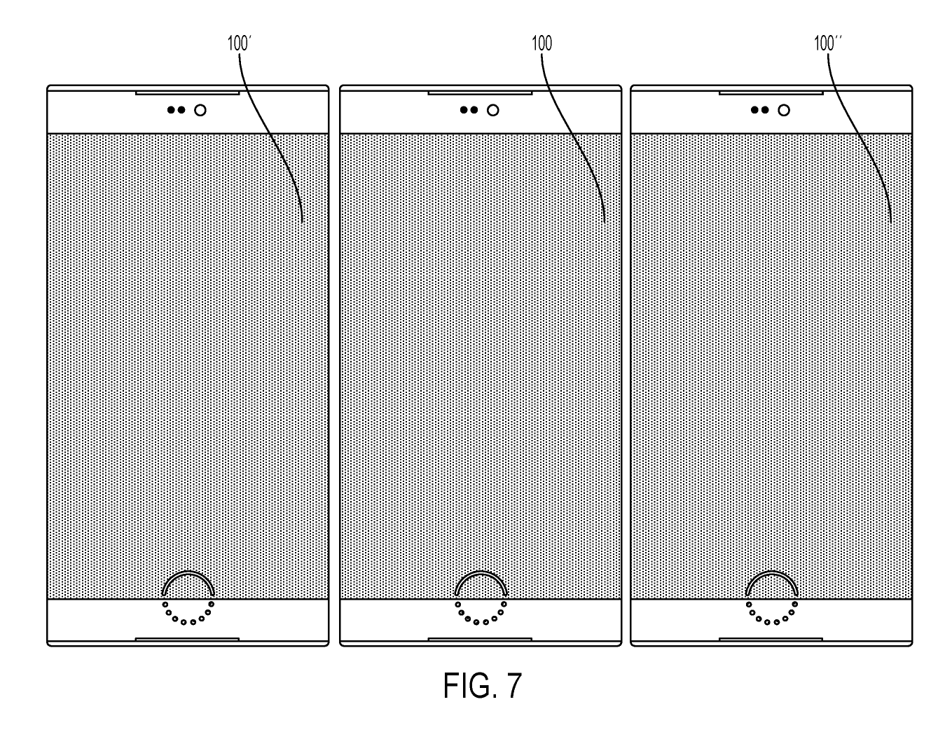

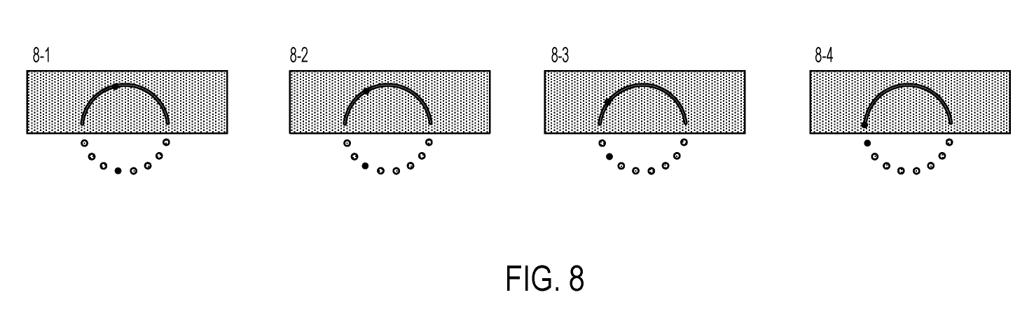

In one example, device 100 may be a device configured to include magnetic connectors as described in patent publication no. WO 2015/070321, the content of which is hereby incorporated by reference. These magnetic connectors allow device 100 to connect to one or more other devices, e.g., devices 100′ to its left and/or device 100″ to its right, as shown in FIG. 7. In this example, the animation sequence displayed using indicator 150 may identify which of devices 100′ and 100″ that device 100 is interacting with. For example, a leftward moving sequence as shown in FIG. 8 may be used to indicate that device 100 is interacting (e.g., is pairing with, transmitting power/data therewith) with a device on its left (i.e., device 100′). A similar rightward moving sequence may be used to indicate that device 100 is interacting with a device on its right (i.e., device 100″). Device 100 may display the animation sequence by first detecting one or more connected devices which may trigger different controls by device 100 of both the LEDs forming indicator portion 154 and pixels of display 102 forming indicator portion 152 depending on the desired visual effect.

As noted, the indicator 150 may be used to provide an indication of the device state. A further example device state is a pairing state has one or more corresponding visual effects to indicate that device 100 is magnetically connected to one or more other devices 100 e.g., devices 100′ to its left and/or device 100″ to its right, as shown in FIG. 7. The indicator 150 has a visual effect that may be used to indicate the pairing state.

According to some embodiments, magnetically connected devices 100 with indicators 150 generate synchronized visual effects across indicators 150 of the magnetically connected devices 100. Each device 100 has indicator 150 having a first visual indicator portion 152 and a second visual indicator portion 154. The connected devices 100 are configured to exchange control signals to generate a synchronized visual animation effect using the indicators 150. Display of the animation sequence across multiple devices requires communication between devices 100 for control by each device 100 of both the LEDs forming indicator portion 154 and pixels of display 102 forming indicator portion 152. Synchronization messages can be communicated by way of messages transmitted over a data bus established through the magnetic connectors, or through a wireless channel between the devices (e.g., WiFi, Bluetooth). In some embodiments, devices 100 communicate with a central server (e.g., connected through the Internet) that coordinates the animation on each of the devices 100.

The physical relationship between the devices 100, 100′, 100″ may be important over a duration of the magnetic connection session. The indicator 150 provides an enhanced notification to a user of what devices 100, 100′, 100″ are communicating and the flow of data exchange by the direction of the synchronized visual effects or other feature of the synchronized visual effects. For example, there may be data flow or upload from one device 100 to another device 100 and the direction of the synchronized visual effects may illustrate that data flow. There may also be a power management system between devices 100, 100′, 100″. The synchronized visual effects may provide a notification of a host device and slave devices.

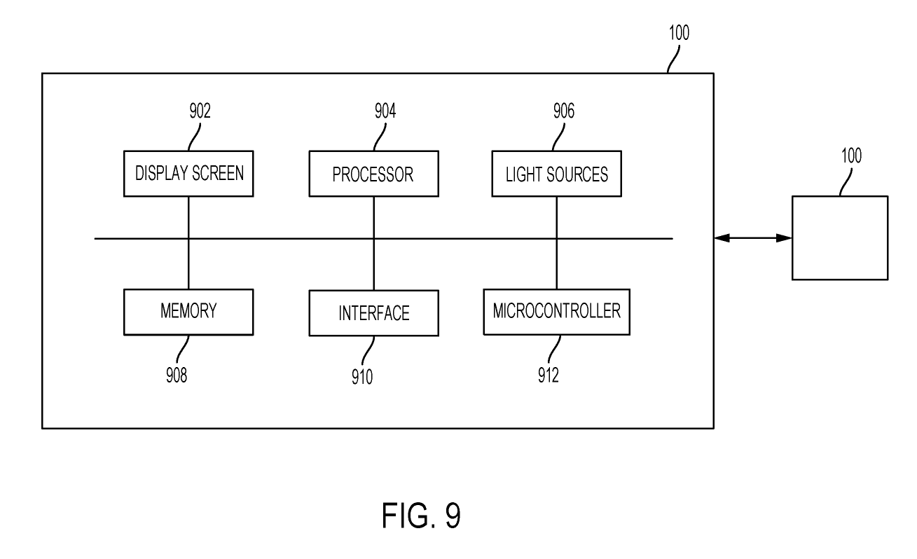

FIG. 9 is a view of components of a device 100 according to some embodiments. The device 100 has a processor 904, memory 908, a display screen 902, and light sources 906. The light sources 906 can be disposed in the bezel 104 (FIG. 1) adjacent the display screen 902.

Processor 904 controls the light sources 906 forming indicator portion 154 and pixels of display 102 forming indicator portion 152 to generate synchronized visual effects. Processor 904 determines a current device state and the visual effect for the current device state. For example, processor 904 may determine that the device 100 is currently charging or connected to another device 100. Processor 904 controls light sources 906 forming indicator portion 154 and pixels of display 902 forming indicator portion 152 to generate the visual effect for the current device state. Processor 904 generates one type of control commands for display screen 902 and another type of control commands for microcontroller 912. Microcontroller 912 controls light sources 906 in response to control commands from processor 904. The device has an interface 910 for coupling to other devices, peripherals, or networks. Interface 910 may receive communication signals from other devices 100 (including magnetically connected devices 910). Processor 904 receives the communication signals which may trigger generation of control commands for visual effects.

Processor 904 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 908 is computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Interface 910 enables device 100 to interconnect with one or more input devices, such as a keyboard, mouse, camera, touch screen and a microphone, or with one or more output devices such as a display screen and a speaker. Interface 910 enables device 100 to communicate with other components, to exchange data with other components, to access and connect to network resources, to serve applications, and perform other computing applications by connecting to a network (or multiple networks) capable of carrying data.

Device 100 is operable to register and authenticate users (using a login, unique identifier, and password for example) prior to providing access to applications, a local network, network resources, other networks and network security devices. Devices 100 may serve one user or multiple users. Device 100 is operable to generate different visual effects for different users.

As noted, device 100 is configured to provide a first visual indicator portion 152 defined by at least part of the display screen 902 and a second visual indicator portion defined by the light sources 906. The first visual indicator portion 152 (FIG. 2) and the second visual indicator portion 154 are in close physical proximity and cooperatively formi the dual-media visual indicator 150. Processor 904 is configured to execute instructions in the memory 908 to issue a first control command for the first visual indicator 152, and a second control command for the second visual indicator 154. The processor 904 controls the first visual indicator portion 152 and the second visual indicator portion 154 to generate synchronized visual effects or animations of the indicator 150. The processor 904 can selectively activate the display screen 902 and the light sources 906 using control commands to generate the synchronized visual effect. The processor 904 generates different types of control commands for controlling the display 902 and the light sources 906, respectively.

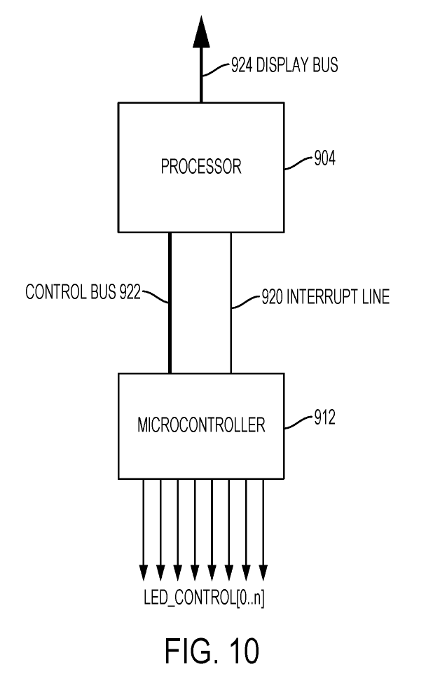

FIG. 10 shows a diagram of processor 904 interacting with microcontroller 912 and display bus 924 to generate synchronized visual effects. Processor 904 executes software governing device states and visual effects of the dual-media indicator to generate control commands. In an embodiment, processor 904 may be a general purpose mobile processor (e.g., a Qualcomm processor, an Intel processor, an MTK processor, or the like). The processor 904 is connected to a display screen 902 (e.g., a LED screen) by a display bus 924 (e.g., a MIPI bus). The processor 904 is also connected to a microcontroller 912 (e.g., a ATmega328 microcontroller) by way of a control bus 922 (e.g., an I2C bus). Microcontroller 912 is responsive to control commands generated by processor 904 and controls light sources using control signals. The microcontroller 912 is configured to perform specific tasks, such as controlling whether the LEDs are on or off through the LED_CONTROL[0..n] signals.

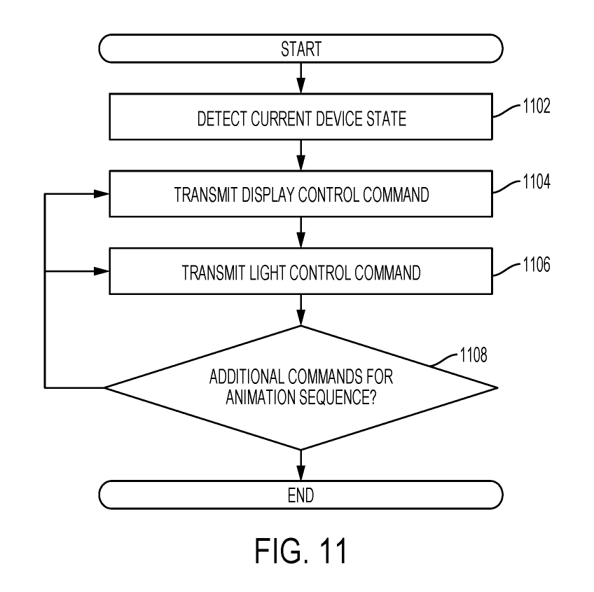

FIG. 11 shows a flowchart of a process for generating synchronized visual effects using indicator 150. The synchronized visual effects define one or more animation sequences. Each animation sequence has multiple portions including both visual display portions and visual light portions. Visual display portions are indicated by the first visual indicator 152 and visual light portions are indicated by the second visual indicator 154. Operation of indicator 150 is described with reference to an example animation sequence including a first portion presented on the display screen 902, a second portion presented by light sources 906, and a third portion presented on the display screen 902. Other animations sequences are possible.

At 1102, processor 904 determines the current device state. Different device states may correspond to different visual effects and animation sequences. Processor 904 uses the device state to generate control commands applicable to the corresponding visual effect. A visual effect defines an animation sequence with multiple portions. The portions include visual display portions and visual light portions. Different control commands trigger generation of the different portions of the animation sequence by the first visual indicator 152 and the second visual indicator 154. There can be a default visual effect and animation sequence if the device state is not determined.

At 1104, processor 904 transmits a display control command for a first portion of the animation sequence to the display bus 924 and display screen 902 of the device 100. The display control command defines a visual display portion of the animation sequence. The visual display portion of the animation sequence is display data that defines a pattern of pixels or series of image frames for activation by the display bus 924 in response to the display control command, for example. The display control command may trigger selective activation of the pixels of the display screen 902 to generate a visual display animation sequence for the first visual indicator portion 152. The processor 904 transmits display data (e.g., corresponding to a series of frames) to the display screen 902 by way of the display bus 924. The processor 904 may detect when pixels proximate an edge of display screen 902 or proximate the second visual indicator are activated. This may trigger a visual light portion of the animation sequence.

At 1106, processor 904 transmits a light control command for a second portion of the animation sequence to a control bus 922 and a microcontroller 912. The light control command defines a visual light portion of the animation sequence. The visual light portion defines a pattern of light sources for selective activation by the microcontroller 912 in response to the light control command. For the second portion, the processor 904 transmits control data to the microcontroller 912 by way of the control bus 922. The light control command has control data that describes a particular LED sequence (e.g., which LED to activate and when to active the respective LED) for activation by the microcontroller 912.

The visual light portion of the animation sequence is implemented by selective activation of the light sources to emit light through the apertures. In some embodiments, the visual light portion of the animation sequence is implemented by selective activation of the light sources embedded on the bezel.

Optionally, the microcontroller 912 may store a number of pre-defined sequences in its own memory, and the control data simply identifies one of these pre-defined sequences. Optionally, when the microcontroller 912 has displayed the desired LED sequence (by activating the LEDs through the LED_CONTROL[0..n] signals), it sends an interrupt signal (along the interrupt line 920 of FIG. 10) to the processor 904, indicating that it is done. This interrupt signal may be used by processor 904 to trigger another display control command or light control command, to generate visual effects spanning a sequence of commands.

Optionally, the processor 904 may know the duration of the second sequence and begin the third sequence after that duration of time has elapsed. Processor 904 may couple to a system clock to calculate the duration of time elapsed. In this embodiment, the microcontroller 912 does not need to send an interrupt signal.

The order of 1104 for transmission of a display control command and 1106 for a light control command is a non-limiting illustrative example. In some embodiments, the processor 904 may transmit a light control command before transmitting a display control command depending on the visual effect and the animation sequence. In some embodiments, the processor 904 may concurrently or simultaneously transmit a display control command (at 1104) and a light control command (at 1106). The portions of the animation sequence may be concurrently or simultaneously generated. The first visual indicator portion 152 and the second visual indicator 154 operate in synchronization to define a visual element using both a visual display portion and a visual light portion within a region of the indicator 150 during operation of the device 100. The animation sequence indicates a device state within the region of the indicator 150, for example. Different visual animation effects and different sequences of visual animation effects indicate different device states.

At 1108, the processor 904 determines if there are additional portions of the animation sequence to generate using indicator 150. The additional portions may be visual display portions or visual light portions. If there is an additional visual display portion for the animation sequence then the processor returns to 1104 to transmit an additional display control command. If there is an additional visual light portion for the animation sequence then the processor returns to 1106 to transmit an additional light control command.

For example, processor 904 can transmit a second display control command for a third portion of the animation sequence to the display 902 by way of a display bus 924. The second display control command defines a second visual display animation sequence that may be different than the first visual display animation sequence.

In an embodiment, indicator 150 may also serve as a button (e.g., a power button or a home button). In this case, display screen 102 may be a touch-sensitive display and device 100 may be configured to detect touches within a region of screen 102 covered by indicator portion 152. Such touches may be treated as a button press of indicator 150. Optionally, a touch sensor (e.g., capacitive touch sensor) may be replaced under bezel 104 to detect such button presses.

In some embodiments, upon touch activation of the indicator 150, the first visual indicator portion 152 transmits a first user input signal to the processor 904. The second visual indicator portion 154 transmits a second user input signal to the processor 904. The processor 904 is responsive to the first user input signal and the second user input signal for controlling operation of the device 100. The portion of the display screen 902 for the first visual indicator portion 152 can be touch sensitive and the portion of the bezel aligned with the light sources 906 can be touch capacitive. The first visual indicator portion 152 and the second visual indicator portion 154 operate together to provide the touch activation for the indicator 150. The user input signal and trigger device 100 to transition to a device state.

The indicator 150 may provide notification to user of a current device state which may identify available user input signals for controlling operation of the device 100. Activation of the indicator 150 triggers different control operations for the device 100 depending on the current device state. The indicator 150 provides visual effects to notify the user of the current device state and the operation that may trigger upon activation.

In some embodiments, the indicator 150 has different event states to trigger different user input commands depending on a current event state. The event states may link to different applications of the device 100, for example. By way of example, an application may be a gaming application and the event states may link to different actions or events occurring within the gaming application. Activation of the indicator may trigger different user input commands depending on the current event within the gaming application. Event states may also be referred to generally as device states. Another example event may relate to device state. For example, an event may be a detected low power level for the device 100. The animation sequence may indicate the detected low power level as an alert for the user. The visual display animation may indicate the level of battery that remains. The visual light animation may indicate the detected low power level alert. The indicator 150 may indicate the presence of other pairable devices 100. In some embodiments, activation of the indicator 150 can trigger a pairing operation. In some embodiments, the indicator 150 can indicate that there is a current pairing operation and activation of the indicator 150 may cancel that paring operation.

In some embodiments, the indicator 150 has different operating modes. For example, the indicator 150 has a full power mode and a low power mode. The visual effects may vary depending on the operating mode. For example, the lower power mode may trigger reduced visual effects to conserve power.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### General

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A device comprising a processor, a storage unit, a display, and a plurality of light sources disposed in a bezel adjacent the display, the device configured to provide a first visual indicator portion defined by at least part of the display and a second visual indicator portion defined by the plurality of light sources disposed in the bezel, the first visual indicator portion and the second visual indicator portion being in close physical proximity and cooperatively forming a dual-media visual indicator, the processor configured to execute instructions in the storage unit to issue a first control command for the first visual indicator portion, and a second control command for the second visual indicator portion, thereby controlling the first visual indicator portion and the second visual indicator portion to generate a visual effect of the dual-media visual indicator.

2. The device of claim 1 wherein upon touch activation of the dual-media indicator, the first visual indicator portion transmits a first user input signal to the processor and the second visual indicator portion transmits a second user input signal to the processor, the processor being responsive to the first user input signal and the second user input signal for controlling operation of the device.

3. The device of claim 1 wherein the processor controls the first visual indicator portion and the second visual indicator portion using the first control command and the second control command, respectively, to generate the visual effects in synchronization across the first visual indicator portion and the second visual indicator portion.

4. The device of claim 2 wherein the dual-media visual indicator has a plurality of event states to trigger different user input commands depending on a current event state.

5. The device of claim 1 wherein the processor selectively activates the first visual indicator portion and the second visual indicator portion using the first control command and the second control command to generate the visual effect.

6. The device of claim 1 wherein the first control command and the second control command are different types of control commands for controlling the display and the plurality of light sources, respectively.

7. The device of claim 1 wherein the second visual indicator portion comprises a microcontroller for controlling the plurality of light sources, the microcontroller being responsive to the second control command.

8. The device of claim 1 wherein the second visual indicator portion is formed as a plurality of apertures on the bezel aligned with the plurality of light sources to emit light through the apertures.

9. The device of claim 8 wherein the processor generates the visual effect by controlling the plurality of light sources to emit light through the apertures using the second control command.

10. The device of claim 8 wherein the apertures are sized to not be visible to eye when the plurality of light sources are not emitting light.

11. The device of claim 8 further comprising a transparent cover over at least one of the apertures.

12. The device of claim 8 further comprising at least one lens to focus light from the plurality of light sources through the apertures.

13. The device of claim 1 wherein the plurality of light sources are embedded on the bezel.

14. The device of claim 1 wherein the device comprises a microcontroller for controlling the plurality of light sources, the microcontroller being responsive to the second control command.

15. The device of claim 1 wherein the processor controls the first visual indicator portion using a display bus coupled to the display and the second visual indicator portion using a microcontroller for controlling the plurality of light sources.

16. The device of claim 1 wherein the processor controls the first visual indicator portion and the second visual indicator portion in synchronization to define a visual element within the indicator region during operation of the device.

17. The device of claim 1 wherein the processor determines a device state and triggers the first control command and the second control command to generate the visual effect to indicate the device state.

18. The device of claim 1 wherein the second visual indicator portion is formed by the plurality of light sources as a plurality of discrete elements.

19. The device of claim 1 wherein the second visual indicator portion is formed by the plurality of light sources as a continuous element.

20. The device of claim 1 wherein the second visual indicator portion is visible when the display is deactivated.

21. The device of claim 1 wherein the processor triggers the first control command and the second control command to generate, as the visual effect, a plurality of visual animation effects to indicate different device states.

22. The device of claim 2 wherein the part of the display defining the first visual indicator portion is touch sensitive providing the touch activation for the dual-media visual indicator.

23. The device of claim 1 wherein the bezel includes a touch sensor, providing touch activation for the dual-media visual indicator.

24. A system comprising a series of magnetically connected devices, each device comprising a processor, a storage unit, a display, a plurality of light sources disposed in a bevel adjacent the display, each device configured to provide a first visual indicator portion defined by at least a part of the display and a second visual indicator portion defined by at least the plurality of light sources disposed in a bevel, the first visual indicator portion and the second visual indicator portion being in close physical proximity and cooperatively forming a dual-media indicator, the connected devices configured to exchange control signals to generate a synchronized visual effect across the dual-media indicators of the magnetically connected devices, each device configured to execute instructions in the storage unit to issue a first control command for its first visual indicator portion, and a second control command for its second visual indicator portion, thereby controlling the first visual indicator portion and the second visual indicator portion to generate a portion of the synchronized visual effect.

25. A process for generating a synchronized visual effect for a dual-media visual indicator on a device, the synchronized visual effect being an animation sequence including a first portion presented on a display of the device, a second portion presented on a bezel of the device by a light source, and a third portion presented on the display, the process comprising:
transmitting a first display control command for a first portion of the animation sequence to the display of the device by way of a display bus, the first display control command comprising a first visual display animation sequence;
transmitting a light control command for a second portion of the animation sequence to a microcontroller by way of a control bus, the light control command describing a visual light sequence for activation by the microcontroller; and
transmitting a second display control command for a third portion of the animation sequence to the display by way of a display bus, the second display control command comprising a second visual display animation sequence.

26. The process of claim 25 further comprising receiving an interrupt signal from the microcontroller after displaying the visual light sequence.

27. The process of claim 25 further comprising configuring the processor with a time duration of the second portion to trigger the third portion after the time duration has elapsed so that the microcontroller does not need to send an interrupt signal.

28. The process of claim 25 further comprising storing a number of pre-defined sequences in a memory of the microcontroller, wherein the control data identifies one of the pre-defined sequences for the visual light sequence.
